(19) United States
(12) Patent Application Publication
(10) Pub. No.: US 2024/0425080 A1
(43) Pub. Date: Dec. 26, 2024

(54) METHOD AND SYSTEM FOR GENERATING DESTINATION FOR EMERGENCY RESPONSE OF AUTONOMOUS DRIVING SYSTEM

(71) Applicant: ELECTRONICS AND TELECOMMUNICATIONS RESEARCH INSTITUTE, Daejeon (KR)

(72) Inventors: Shin Kyung Lee, Daejeon (KR); Hyun Jeong Yun, Daejeon (KR); Kyoung-Wook Min, Daejeon (KR)

(21) Appl. No.: 18/637,554

(22) Filed: Apr. 17, 2024

(30) Foreign Application Priority Data
Jun. 20, 2023 (KR) 10-2023-0078914

(51) Int. Cl. B60W 60/00; B60W 50/02; B60W 50/029

(52) U.S. Cl. CPC B60W 60/0015; B60W 50/0205; B60W 50/029; B60W 60/0011; B60W 2050/0292; B60W 2554/4044

(57) ABSTRACT

Provided are a method and system for generating a destination for an emergency response of an autonomous vehicle of an autonomous driving system. A method of generating a destination of an autonomous vehicle according to the present invention includes generating forward perception information based on data collected from a sensor mounted on the autonomous vehicle, setting a destination generation area based on the forward perception information, generating a candidate destination in the destination generation area based on the forward perception information and a current heading range of the autonomous vehicle, and when the candidate destination is provided as a plurality of candidate destinations, selecting one destination from among the candidate destinations based on a maximum vertical movement distance of each of the candidate destinations.

### CROSS-REFERENCE TO RELATED APPLICATION

This application claims priority under 35 U.S.C. § 119 to Korean Patent Application No. 10-2023-0078914, filed on Jun. 20, 2023, in the Korean Intellectual Property Office, the disclosure of which is incorporated herein by reference in its entirety.

### BACKGROUND

### 1. Field of the Invention

The present invention relates to a method and system for generating a destination at which an autonomous vehicle will be stopped or parked to take follow-up actions when the autonomous vehicle (surrounding vehicles including an ego-vehicle) drives in an abnormal form while the autonomous vehicle is traveling along a lane.

### 2. Description of Related Art

A fallback situation may inevitably occur due to vehicle failure or surrounding environment while an autonomous vehicle is traveling along a lane. Specifically, the fallback refers to a state in which an operation should be performed to minimize risk when a function of a dynamic driving task (DDT) fails or an autonomous vehicle deviates from an operational design domain (ODD). The autonomous vehicle should perform an emergency stop or emergency parking when the fallback situation occurs.

For reference, the ODD refers to operating conditions under which a particular autonomous driving system or its functions are specifically designed to operate, including environmental, geographical, temporal constraints, presence or absence of specific traffic or road characteristics, etc., and the DDT relates to all real-time operational and tactical functions required to operate vehicles on a road and is a concept that includes longitudinal and lateral vehicle motion control, surrounding environment monitoring, object and event response execution, maneuver planning, etc.

FIG. 1 is a state transition diagram of an autonomous vehicle operated by a conventional autonomous driving system to process abnormal situations in the autonomous vehicle.

The conventional autonomous driving system is based on the premise that a driver should get on board. According to the state transition diagram in FIG. 1, the autonomous driving system takes over a state depending on the occurrence of events while operating manual, autonomous driving ready (auto-rdy), autonomous driving (auto), system limit (sys_limit), and system fail (sys_fail) states. The auto and sys_limit states correspond to an autonomous driving priority mode, and the manual, auto-rdy, and sys_fail states correspond to a driver priority mode. For example, when the conventional autonomous driving system detects a failure in an autonomous driving situation (auto state), the autonomous driving system generates visual/auditory warning messages and then performs the takeover to a driver mode (manual state) until the system fail is resolved. FIG. 1 illustrates five states of the autonomous vehicle, but the number and definition of states may vary depending on manufacturers of the autonomous driving system.

Meanwhile, the conventional autonomous driving system requests take over from a driver even if situations such as performance degradation rather than the system fail are detected, and decelerates a vehicle and then stops the vehicle when the takeover by the driver does not occur within a certain period of time.

That is, the conventional autonomous driving system responds to emergencies in a manner to immediately decelerate a vehicle and stop the vehicle on the relevant lane when the takeover by the driver does not occur. This response method does not take into account information on perception, determination, and control of the autonomous driving system and a state of a subsystem. Therefore, when responding to the emergencies according to the above-described method, there is a problem of increasing congestion because the state of the autonomous vehicle and surrounding traffic conditions are not considered.

Meanwhile, at level 4 or higher autonomous driving, an appropriate minimal risk maneuver (MRM) should be selected depending on the state of the autonomous driving system to perform an emergency stop or emergency parking of the autonomous vehicle. To select the appropriate MRM, there is a need to determine an optimal destination at which the vehicle will be stopped or parked in consideration of considering information (e.g., perceptual information of surrounding objects) on surrounding traffic conditions and the state (e.g., brake/heading control, movable distance) of the autonomous driving subsystem, etc.

### Related Art Document

### Non-Patent Document

(Non-Patent Document 1) Bong-seop Kim, Myeong-soo Lee, and Tae-ho Lim, “Development of Validation Technology for Operation Rights SW Safety and Response According to Fallback MRC of Edge-Based Autonomous Driving Function,” The Korean Institute of Communications and Information Sciences Summer Conference Papers 2021, pp. 409-410, 2021.

### SUMMARY

The present invention is directed to providing a method and system for generating a destination of a vehicle in consideration of a state of a subsystem of an autonomous driving system in performing an emergency response due to abnormal situations while an autonomous vehicle is traveling along a lane.

Specifically, the present invention is directed to providing a method and system for generating a destination for an emergency response of an autonomous driving system that are capable of distinguishing a location where a vehicle can stop based on object perception results for a space around the autonomous vehicle, generating prioritized candidate destination paths based on a controllable state, and then minimizing subsequent collisions by selecting a maximum movable destination.

The objects of the present invention are not limited to the above-described aspects, and other objects that are not described may be obviously understood by those skilled in the art from the following specification.

According to an aspect of the present invention, there is provided a method of generating a destination for an emergency response of an autonomous vehicle, including: generating forward perception information based on data collected from a sensor mounted on the autonomous vehicle; setting a destination generation area based on the forward perception information; generating a candidate destination in the destination generation area based on the forward perception information and a current heading range of the autonomous vehicle; and when the candidate destination is provided as a plurality of candidate destinations, selecting one destination from among the candidate destinations based on a maximum vertical movement distance of each of the candidate destinations.

The method of generating a destination may further include excluding lane information from the forward perception information.

The method of generating a destination may further include: perceiving an object in front of the autonomous vehicle based on the forward perception information and determining a location and movement direction of the object; and setting a risk area based on the location and movement direction of the object and excluding the risk area from the destination generation area.

In the generating of the candidate destination, a point that is reached only after passing through the risk area may be excluded from the candidate destination.

In the selecting of the destination, when the candidate destination is provided as a plurality of candidate destinations, one destination may be selected from the candidate destinations based on a heading value and the maximum vertical movement distance maintained to reach each of the candidate destinations.

According to another aspect of the present invention, there is provided a system for generating a destination for an emergency response of an autonomous vehicle, including: a perceptual module that generates forward perception information based on data collected from a sensor mounted on the autonomous vehicle; a determination module; and a control module that transmits a current heading range of the autonomous vehicle to the determination module.

The determination module may set a destination generation area based on the forward perception information, generate a candidate destination in the destination generation area based on the forward perception information and a current heading range of the autonomous vehicle, and when there are the plurality of candidate destinations, select one destination from among the candidate destinations based on maximum vertical movement distances of each of the candidate destinations.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a state transition diagram of an autonomous vehicle operated by a conventional autonomous driving system to process abnormal situations in the autonomous vehicle;

FIG. 2 is a state transition diagram of the autonomous vehicle operated by the autonomous driving system to process the abnormal situations in the autonomous vehicle according to an embodiment of the present invention;

FIG. 3 is a block diagram illustrating a configuration of a system for generating a destination according to an embodiment of the present invention.

FIGS. 4 and 5 are flowcharts for describing a method of generating a destination according to an embodiment of the present invention;

FIG. 6 is a reference diagram for describing an operation of selecting, by the system for generating a destination according to the present invention, a destination in a drivable area of the autonomous vehicle; and

FIG. 7 is a block diagram illustrating a computer system for implementing the method of generating a destination according to the embodiment of the present invention.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to exemplary embodiments to be described below, but may be implemented in various different forms, these embodiments will be provided only in order to make the present invention complete and allow those skilled in the art to completely recognize the scope of the present invention, and the present invention will be defined by the scope of the claims. Meanwhile, terms used in the present specification are for explaining exemplary embodiments rather than limiting the present invention. Unless otherwise stated, a singular form includes a plural form in the present specification. “Comprise” and/or “comprising” used in the present invention indicate(s) the presence of stated components, steps, operations, and/or elements but do(es) not exclude the presence or addition of one or more other components, steps, operations, and/or elements.

The terms “first,” “second,” etc., may be used to describe various components, but the components are not to be interpreted as limited by the terms. These terms may be used to differentiate one component from other components. For example, a “first” component may be named a “second” component and a “second” component may also be similarly named a “first” component, without departing from the scope of the present invention.

It is to be understood that when a first element is referred to as being “connected to” or “coupled to” a second element, the first element may be connected directly to or coupled directly to the second element or be connected to or coupled to the second element with a third element interposed therebetween. On the other hand, it should be understood that when a first element is referred to as being “connected directly to” or “coupled directly to” a second element, the first element may be connected to or coupled to the second element without a third element interposed therebetween. In addition, other expressions describing a relationship between components, that is, “between,” “directly between,” “neighboring to,” “directly neighboring to,” and the like, should be similarly interpreted.

When it is determined that the detailed description of the known art related to the present invention may unnecessarily obscure the gist of the present invention, a detailed description therefor will be omitted.

Hereinafter, embodiments of the present disclosure will be described in detail with reference to the accompanying drawings. The same means will be denoted by the same reference numerals throughout the accompanying drawings in order to facilitate the general understanding of the present invention in describing the present invention.

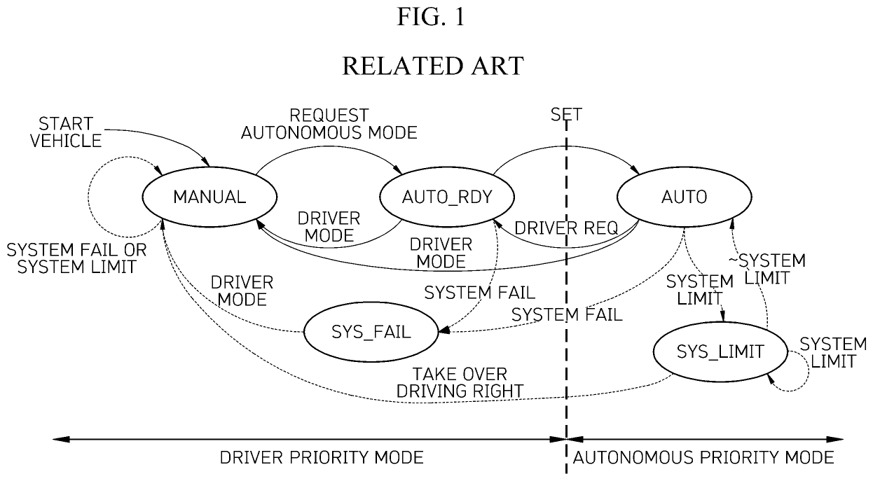

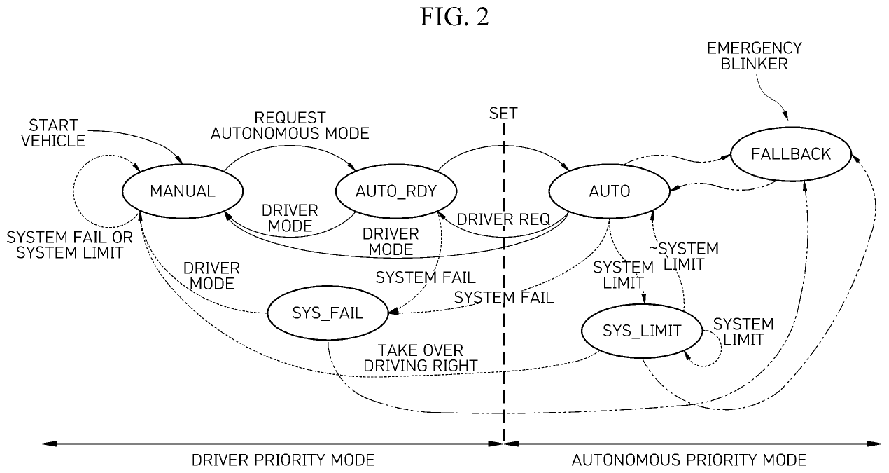

FIG. 2 is a state transition diagram of the autonomous vehicle operated by the autonomous driving system to process the abnormal situations in the autonomous vehicle according to an embodiment of the present invention. The state transition diagram in FIG. 2 illustrates that a fallback state is added to the state transition diagram in FIG. 1.

As illustrated in FIG. 2, there are three paths to enter the fallback state. In a system fail situation such as sensor abnormality, a sys_fail state is taken over to the fallback state, and when performance is degraded (e.g., the accuracy of output of a perceptual model is 90% or less), the sys_limit state is taken over to the fallback state, and when a route may not be set due to the influence of the surrounding environment or nearby objects, an auto state is taken over to the fallback state.

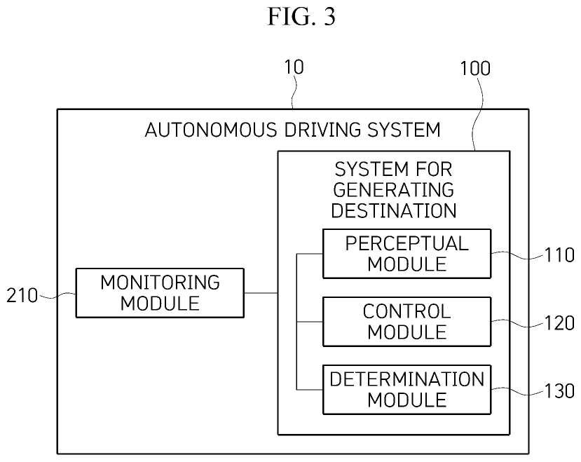

FIG. 3 is a block diagram illustrating a configuration of a system for generating a destination of an autonomous vehicle according to an embodiment of the present invention.

In this specification, the “destination” refers to either a stop location or a parking location of the autonomous vehicle.

The autonomous driving system 10 according to the embodiment of the present invention includes a system 100 for generating a destination and a monitoring module 210.

The system 100 for generating a destination of an autonomous vehicle (hereinafter abbreviated as “system for generating a destination”) according to the embodiment of the present invention is included in the autonomous driving system 10 and generates a destination at which the autonomous vehicle will be stopped or parked to respond to fallback emergency. In this case, the system 100 for generating a destination generates the destination in consideration of a subsystem of the autonomous driving system 10 and a state of each module of the system 100 for generating a destination.

The system 100 for generating a destination includes a perceptual module 110, a control module 120, and a determination module 130. The system 100 for generating a destination illustrated in FIG. 3 is according to an embodiment, and components of the system 100 for generating a destination according to the present invention are not limited to the embodiment illustrated in FIG. 3, but may be added, changed or deleted, if necessary.

The perceptual module 110 generates forward perception information based on data collected from sensors mounted on the autonomous vehicle.

The control module 120 transmits a maximum deceleration and a current heading range of the autonomous vehicle to the determination module 130.

The determination module 130 sets the destination generation area based on the forward perception information, generates a candidate destination in a destination generation area based on the forward perception information and the current heading range of the autonomous vehicle, and when there are a plurality of candidate destinations, selects one destination from among the candidate destinations based on a maximum vertical movement distance of each candidate destination. In this case, the determination module 130 may select a destination by reflecting the heading value for reaching each candidate destination. The maximum vertical movement distance refers to the longest distance in the longitudinal direction (forward direction).

The determination module 130 may exclude lane information from the forward perception information and set the destination generation area based on the forward perception information excluding the lane information.

The determination module 130 perceives an object in front of the autonomous vehicle based on the forward perception information and determines a location and movement direction of the object. The determination module 130 may set a risk area based on the location and movement direction of the object and exclude the risk area from the destination generation area.

In the process of generating the candidate destination, the determination module 130 may exclude points that may be reached only after passing through the risk area from the candidate destination.

The monitoring module 210 may recognize the states of the perceptual module 110 and the control module 120, and transmit state information on the perceptual module 110 and the control module 120 to the determination module 130. As another example, the perceptual module 110 and the control module 120 may diagnose their own state and transmit their state information to the monitoring module 210 or the determination module 130.

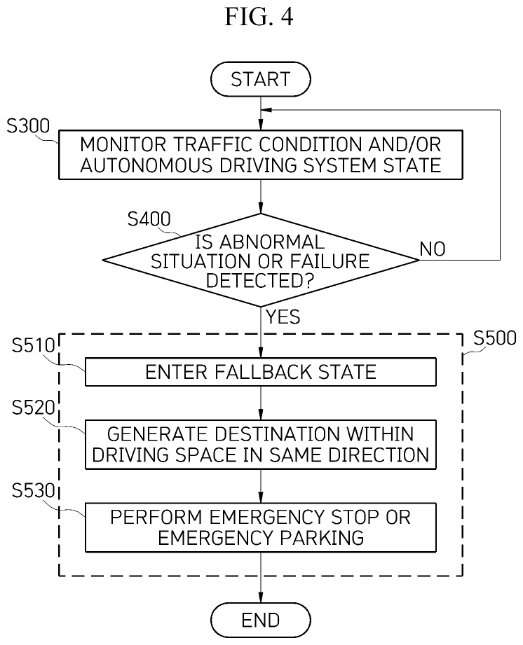

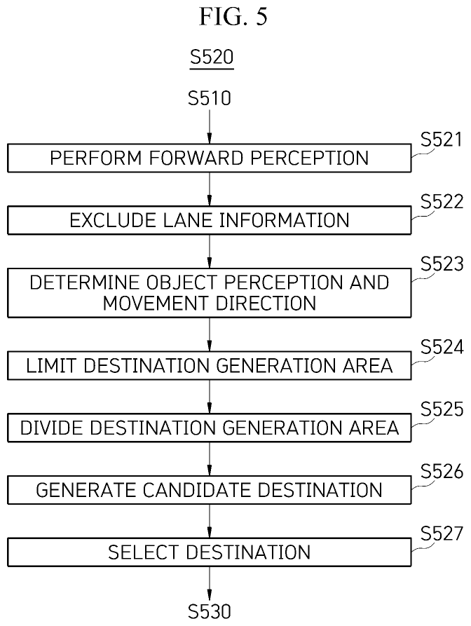

The detailed functions of each of the modules 110, 120, and 130 of the system 100 for generating a destination may be understood with reference to flowcharts of FIGS. 4 and 5, which will be described below.

FIGS. 4 and 5 are flowcharts for describing a method of generating a destination of an autonomous vehicle of an autonomous driving system according to an embodiment of the present invention. The method of generating a destination in FIGS. 4 and 5 assumes a situation where a driver does not get in an autonomous vehicle.

Referring to FIG. 4, the method of generating a destination of an autonomous vehicle (hereinafter abbreviated as “method of generating a destination”) according to the embodiment of the present invention includes operations S300 to S500. Operation S500 includes operations S510 to S530. Referring to FIG. 5, operation S520 includes operations S521 to S527.

The method of generating a destination illustrated in FIGS. 4 and 5 is according to an embodiment, and operations of the method of generating a destination according to the present invention are not limited to the embodiment illustrated in FIGS. 4 and 5, but may be added, changed or deleted, if necessary.

The method of generating a destination illustrated in FIGS. 4 and 5 is a method of generating a destination of an autonomous vehicle in consideration of the state of the subsystem of the autonomous driving system 10 in order to respond to the fallback emergency.

Operation S300 is an operation of monitoring traffic conditions and/or the state of the subsystem of the autonomous driving system. The monitoring module 210 receives data collected or generated by the perceptual module 110, the control module 120, and the determination module 130 while the autonomous vehicle is operating in an autonomous driving mode, and detects whether failure or abnormal situations occur based on the received data. The data includes traffic conditions (e.g., weather, movement of objects, obstacles, etc.) around the autonomous vehicle and state information of each of the modules 110, 120, and 130 of the system 100 for generating a destination.

Operation S400 is an operation of determining whether the abnormal situations or failure is detected. The autonomous driving system 10 performs operation S500 when the monitoring module 210 detects the abnormal situations or failure, and otherwise performs operation S300 again.

Operation S500 is an operation in which a fallback strategy is performed to respond to the abnormal situations or failure. When the failure or abnormal situations of the autonomous vehicle are detected, the autonomous driving system 10 enters the fallback state (S510) and performs the fallback strategy 200 of the autonomous driving system 10 without a driver.

When the autonomous driving system 10 enters the fallback state, the system 100 for generating a destination analyzes risk factors within the entire driving space where vehicles are not be in a basic autonomous driving mode that drives along a current lane, but move in the same direction in the currently perceived road areas, generates candidate destinations at which a target autonomous vehicle may be reached by driving on a route that may avoid these risk factors, and then determines a destination having the highest priority as a final destination (S520). Operation S520 corresponds to the method of generating a destination by the system 100 for generating a destination.

The autonomous driving system 10 performs emergency stop or emergency parking at the determined destination (S530).

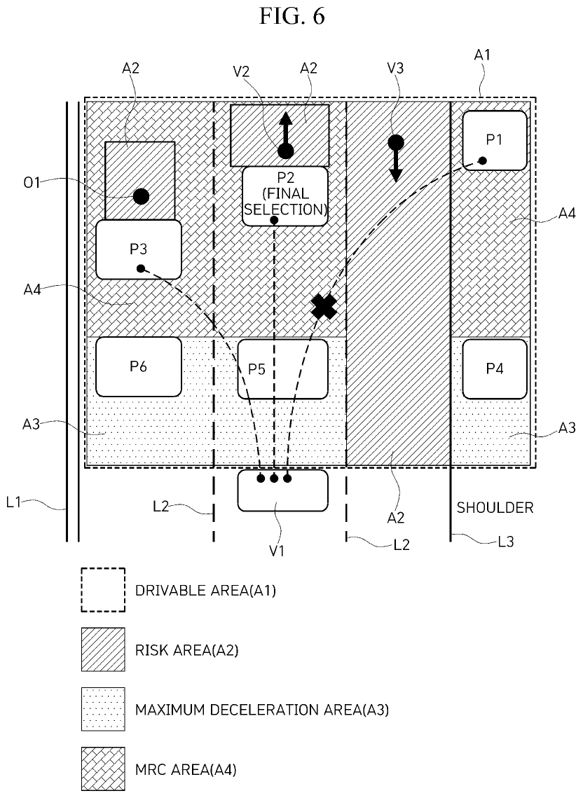

FIG. 5 is a flowchart specifically illustrating operation S520 in FIG. 4, that is, the method of generating a destination of an autonomous vehicle by the system 100 for generating a destination. FIG. 6 is a reference diagram for describing an operation of selecting, by the system 100 for generating a destination according to the present invention, a destination in a drivable area of the autonomous vehicle. Refer to FIG. 6 while describing the method of generating a destination illustrated in FIG. 5. In FIG. 6, L1 denotes a center line, L2 denotes a dotted line dividing a lane, and L3 denotes a solid line lane dividing a lane and a shoulder.

When the monitoring module 210 of the autonomous driving system 10 detects the failure or abnormal situations of the autonomous vehicle, the autonomous driving system 10 enters the fallback state, and updates a stop point or a parking point to a new location where risk may be minimized through the method of generating a destination according to the present invention to a new destination.

Operation S521 is a forward perception operation. When the perceptual module 110 is normal, based on the current location of the target autonomous vehicle, information (hereinafter referred to as “forward perception information”) on front objects and roads is generated based on data collected from sensors (e.g. camera, lidar, radar) mounted on the autonomous vehicle. The perceptual module 110 transmits the forward perception information to the determination module 130.

Operation S522 is a lane information exclusion operation, and operation S523 is an object perception and movement direction determination operation. In order to minimize the risk of collisions (including tailgating), on roads where the flow of vehicles is in the same direction, a location that does not interfere with movement of other vehicles should be able to be selected as the destination for stopping/parking, without having to limit space by being confined to a lane. Therefore, the determination module 130 excludes the lane information from the forward perception information (S522), and based on the forward perception information excluding the lane information, perceives vehicles or obstacle objects other than the target autonomous vehicle V1 (same meaning as ‘ego vehicle’), classifies objects into dynamic objects and static objects, and determines a movement direction of the perceived objects (S523).

Unlike the above-described embodiment, the perceptual module 110 may perform operations S522 and S523. That is, the perceptual module 110 may exclude lane information L2 and L3 from the forward perception information, perceive vehicles V2 and V3 other than an Ego vehicle V1 or an obstacle object O1 based on the forward perception information, classify objects into dynamic objects and static objects, and determine the movement direction of perceived dynamic objects V2 and V3. In this case, the perceptual module 110 transmits forward perception information excluding the lane information L2 and L3, object perception results (including the position of the object), object classification results, and a movement direction of an object to the determination module 130.

Operation S524 is an operation of defining a destination generation area. The determination module 130 sets an initial destination generation area based on the forward perception information excluding the lane information. The determination module 130 sets a risk area based on the object location and the moving direction of the object. The determination module 130 excludes the risk area from the initial destination generation area. This will be described in detail.

First, the determination module 130 generates a drivable area A1 based on the forward perception information excluding the lane information L2 and L3, and sets the drivable area A1 as the initial destination generation area. The destination generation area refers to an area where the destination of the Ego vehicle V1 may be selected.

The object is classified into the static object and dynamic object in operation S523, and the determination module 130 considers a longitudinal space in which the dynamic object V2 is moving as a risk area A2, and excludes the risk area A2 from the destination generation area.

When the dynamic object V3 is moving toward a target autonomous vehicle (ego vehicle V1), the determination module 130 considers the entire longitudinal space in which the object V3 is moving as the risk area A2, and excludes the corresponding risk area A2 from the destination generation area. This is because, when the dynamic object V3 is moving toward the ego vehicle V1, a situation with a high risk of collision may occur.

Since the static object O1 such as an obstacle interferes with the forward driving of the ego vehicle V1, the determination module 130 excludes a predetermined range of space including the location of the static object O1 from the destination generation area.

Operation S525 is an operation of dividing the destination generation area.

The determination module 130 may divide the destination generation area according to the controllable state of the ego vehicle V1. The determination module 130 divides the destination generation area in a manner to set, based on a longitudinal direction, an area from a current position of the ego vehicle V1 to a point where it may be stopped in the fastest time through maximum deceleration as a maximum deceleration area A3 in the destination generation area and set an area after the maximum deceleration area A3 as an MRC area A4 in the destination generation area. The control module 120 transmits the current speed and maximum deceleration of the ego vehicle V1 to the determination module 130, and the determination module 130 sets the maximum deceleration area A3 and the MRC area A4 based on the destination generation area, the current speed, and the maximum deceleration.

Even when a vehicle may be driven sufficiently, there is no need to force the vehicle to decelerate and stop. Accordingly, the determination module 130 sets the priority of the destination belonging to the maximum deceleration area A3 to be lower than that of the destination belonging to the MRC area A4. The process of prioritizing a destination will be described below.

Operation S526 is a candidate destination generation operation.

The control module 120 transmits the current heading range of the ego vehicle V1 to the determination module 130. The determination module 130 generates the candidate destination based on the destination generation area divided into the maximum deceleration area A3 and the MRC area A4 and the heading range of the ego vehicle V1.

The determination module 130 may reflect failure information such as a tire puncture when generating the candidate destination. The determination module 130 may acquire failure information of the ego vehicle V1 from the autonomous driving system 10 or an electronic control unit (ECU) connected to an internal network of a vehicle.

The determination module 130 generates candidate destinations that may be reached through deceleration from areas excluding an area occupied by the ego vehicle V1 in the destination generation area. The determination module 130 subdivides the heading of the vehicle into points that may be moved while maintaining three types (+ value, 0, and − value) based on the heading range of the vehicle in the destination generation area (excluding the area occupied by the ego vehicle) to generate candidate destinations P2, P3, P5, and P6. The determination module 130 may generate candidate destinations for each of the maximum deceleration area A3 and the MRC area A4. In FIGS. 6, P1 and P4 are points that may only be reached by passing through the risk area A2, so the P1 and P4 are excluded from the candidate destinations.

In some cases, the candidate destinations may be generated only in the maximum deceleration area A3, and the candidate destinations may not be generated in the MRC area A4. For example, when an accident occurs and traffic congestion begins ahead, the range in which the autonomous vehicle may stop is limited, so the candidate destinations may only be generated in the maximum deceleration area A3.

Operation S527 is the destination selection operation.

When there are the plurality of candidate destinations, the determination module 130 selects a destination from among the candidate destinations by applying priority criteria. The priority of the candidate destination belonging to the MRC area A4 is higher than the priority of the candidate destination belonging to the maximum deceleration area A3. In addition, the heading value maintains a +value (right direction) and the candidate destinations that may be moved have high priority. In addition, the candidate destinations having the maximum vertical movement distance to give following vehicles a time to prepare by driving far away have high priority. The destinations may be selected by sequentially applying the above-described priorities, or the destination may be selected by applying weights to each priority and adding the weights up.

Referring to FIG. 6, an example of selecting the destinations by sequentially applying priorities will be described.

In operation S526, the determination module 130 generates the candidate destinations P2, P3, P5, and P6 by applying the heading range to the maximum deceleration area A3 and the MRC area A4. The P3 and P6 are points where the Heading is negative, and the P2 and P5 are points where the Heading is 0 or more. The P1 and P4 are points where headings are positive, but points that may only be reached by passing through the risk area A2, so the P1 and P4 are excluded from the candidate destinations.

In operation S527, the determination module 130 selects a destination from among the candidate destinations P2, P3, P5, and P6. The candidate destinations P5 and P6 have been generated in the maximum deceleration area A3, but the candidate destinations P2 and P3 in the MRC area A4 have higher priority, so the candidate destinations should be selected from among the P2 and P3 in the MRC area A4. When comparing the heading values reaching the P2 and P3, there is no heading value having a +value, so the P2 and P3 have equal priority in the heading values. Finally, the determination module 130 selects, as a destination, the candidate destination P2 having the maximum vertical movement distance that may give the following vehicles a time to prepare by driving far away, according to the information collected by the control module 120 or the state of the control module 120.

When the determination module 130 finally selects the destination, the autonomous driving system 10 in the fallback state controls the target autonomous vehicle to move to the selected destination and stop while blinking an emergency light (S530).

In the method of generating a destination according to the embodiment of FIG. 5, the determination module 130 may omit a specific operation according to the state information of the perceptual module 110 and the control module 120 received from the monitoring module 210. For example, when the determination module 130 receives, from the monitoring module 210 or the perceptual module 110, the information that the perceptual module 110 is in an abnormal state, the determination module 130 omits operations S521 to S524, in which the determination is made based on the information provided by the perceptual module 110, and starts from operation S525, in which the determination is made based on the information provided by the control module 120.

In addition, when the determination module 130 receives, from the monitoring module 210 or the control module 120, the information that the control module 120 is in an abnormal state, operations S525 to S527 may be performed based on the preset maximum deceleration amount and heading value or may follow the existing emergency response method of stopping immediately at the current location.

The above-described method of generating a destination has been described with reference to the flowchart illustrated in the drawings. For simplicity, the method has been illustrated and described as a series of blocks, but the invention is not limited to the order of the blocks, and some blocks may occur with other blocks in a different order or at the same time as illustrated and described in the present specification. Also, various other branches, flow paths, and orders of blocks that achieve the same or similar result may be implemented. In addition, all the illustrated blocks may not be required for implementation of the methods described in the present specification.

Meanwhile, in the description with reference to FIGS. 4 to 6, each operation may be further divided into additional operations or combined into fewer operations according to an implementation example of the present invention. Also, some operations may be omitted if necessary, and an order between operations may be changed. In addition, the contents of FIGS. 4 and 6 may be applied to the contents of FIGS. 2 and 3 even when other contents are omitted. Also, the contents of FIGS. 2 and 3 may be applied to the contents of FIGS. 4 to 6.

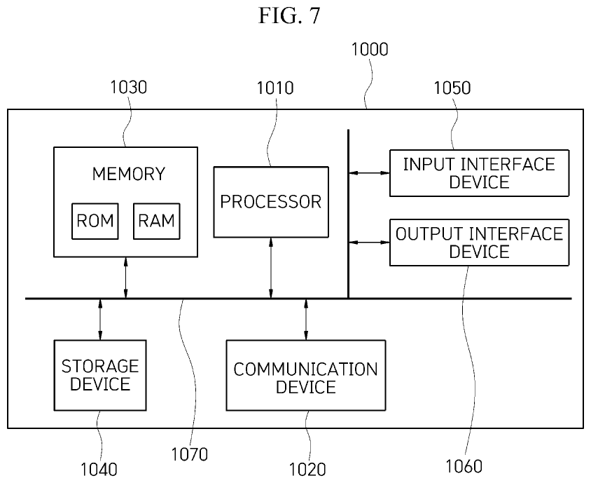

FIG. 7 is a block diagram illustrating a computer system for implementing the method of generating a destination according to the embodiment of the present invention. The system 100 for generating a destination according to the present invention may be implemented in the form of the computer system of FIG. 7.

Referring to FIG. 7, a computer system 1000 may include at least one of a processor 1010, a memory 1030, an input interface device 1050, an output interface device 1060, and a storage device 1040 that communicate through a bus 1070. The computer system 1000 may further include a communication device 1020 coupled to a network. The processor 1010 may be a central processing unit (CPU) or a semiconductor device that executes computer-readable instructions stored in the memory 1030 or the storage device 1040. The memory 1030 and the storage device 1040 may include various types of volatile or non-volatile storage media. For example, the memory may include a read only memory (ROM) and a random access memory (RAM). In the embodiment of the present disclosure, the memory may be located inside or outside the processing unit, and the memory may be connected to the processing unit through various known means. The memory may be various types of volatile or non-volatile storage media, and the memory may include, for example, a ROM or a RAM.

Accordingly, the embodiment of the present invention may be implemented as a computer-implemented method, or as a non-transitory computer-readable medium having computer-executable instructions stored therein. In one embodiment, when executed by the processing unit, the computer-readable instructions may perform the method according to at least one aspect of the present disclosure.

The communication device 1020 may transmit or receive a wired signal or a wireless signal.

In addition, the method according to the embodiment of the present invention may be implemented in the form of program instructions that may be executed through various computer means and may be recorded on a computer-readable recording medium.

The computer-readable recording medium may include a program instruction, a data file, a data structure or the like, alone or a combination thereof. The program instructions recorded on the computer-readable recording medium may be configured by being especially designed for the embodiment of the present invention, or may be used by being known to those skilled in the field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disk read only memory (CD-ROM) or a digital versatile disk (DVD), magneto-optical media such as a floptical disk, a ROM, a RAM, a flash memory, or the like. Examples of the program instructions may include a high-level language code capable of being executed by a computer using an interpreter, or the like, as well as a machine language code made by a compiler.

As described above, the memory 1030 and the storage device 1040 store the computer-readable instructions. The processor 1010 is implemented to execute the above instructions.

In an embodiment of the invention, the processor 1010 executes the instructions to collect data from sensors mounted on the autonomous vehicle and collect the current heading range of the autonomous vehicle. The processor 1010 generates forward perception information based on data collected from a sensor mounted on the autonomous vehicle, sets a destination generation area based on the forward perception information, generates a candidate destination in the destination generation area based on the forward perception information and a current heading range of the autonomous vehicle, and when there are a plurality of candidate destinations, selects one destination from among the candidate destinations based on a maximum vertical movement distance of each of the candidate destinations.

In an embodiment of the present invention, the processor 1010 may exclude the lane information from the forward perception information.

In an embodiment of the present invention, the processor 1010 may perceive the at least one processor perceives an object in front of the autonomous vehicle based on the forward perception information, determine the location and movement direction of the object, set the risk area based on the location and movement direction of the object, and exclude the risk area from the destination generation area.

In an embodiment of the present invention, the processor 1010 may exclude points that may be reached only after passing through the risk area from the candidate destination.

In an embodiment of the present invention, when there are the plurality of candidate destinations, the processor 1010 may select one destination from among the candidate destinations based on the heading value and the maximum vertical movement distance maintained to reach each of the candidate destinations.

For reference, the components according to the embodiment of the present invention may be implemented in the form of software or hardware such as a digital signal processor (DSP), a field programmable gate array (FPGA), or an application specific integrated circuit (ASIC), and perform predetermined roles.

However, “components” are not limited to software or hardware, and each component may be included in an addressable storage medium or reproduce one or more processors.

Accordingly, for example, the component includes components such as software components, object-oriented software components, class components, and task components, processors, functions, attributes, procedures, subroutines, segments of a program code, drivers, firmware, a microcode, a circuit, data, a database, data structures, tables, arrays, and variables.

Components and functions provided within the components may be combined into a smaller number of components or further divided into additional components.

Meanwhile, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in a block(s) of the flow chart. Since the computer program instructions may also be mounted on the computer or the other programmable data processing apparatuses, the instructions performing a series of operations on the computer or the other programmable data processing apparatuses to create processes executed by the computer, thereby executing the computer or the other programmable data processing apparatuses may also provide operations for performing the functions described in a block(s) of the flowchart.

In addition, each block may indicate some of modules, segments, or codes including one or more executable instructions for executing a specific logical function (specific logical functions). Further, it is to be noted that functions mentioned in the blocks occur regardless of a sequence in some alternative embodiments. For example, two blocks that are continuously illustrated may be simultaneously performed in fact or be performed in a reverse sequence depending on corresponding functions.

The term “˜module” used in the present embodiments refers to a software component or a hardware component such as FPGA or ASIC, and the “˜module” performs certain roles. However, the “˜module” is not meant to be limited to software or hardware. The “module” may be configured to be stored in a storage medium that can be addressed or may be configured to regenerate one or more processors. Accordingly, as an example, the “module” refers to components such as software components, object-oriented software components, class components, and task components, processes, functions, attributes, procedures, subroutines, segments of program code, drivers, firmware, microcode, circuits, data, databases, data structures, tables, arrays and variables. Components and functions provided within “˜modules” may be combined into a smaller number of components and “˜modules” or may be further separated into additional components and “˜modules.” In addition, components and “˜modules” may be implemented to play one or more CPUs in a device or a secure multimedia card.

According to an embodiment of the present invention, by generating the destination for the emergency stop or emergency parking in consideration of the surrounding traffic conditions and the state of subsystem (perception-control-determination) when the autonomous driving system performs the emergency response due to the abnormal situations, it is possible to minimize the subsequent collisions and traffic congestion.

Effects which can be achieved by the present invention are not limited to the above-described effects. That is, other objects that are not described may be obviously understood by those skilled in the art to which the present invention pertains from the following description.

Although exemplary embodiments of the present invention have been disclosed above, it may be understood by those skilled in the art that the present invention may be variously modified and changed without departing from the scope and spirit of the present invention described in the following claims.

What is claimed is:

1. A method of generating a destination for an emergency response of an autonomous vehicle, the method comprising:
generating forward perception information based on data collected from a sensor mounted on the autonomous vehicle;
setting a destination generation area based on the forward perception information;
generating a candidate destination in the destination generation area based on the forward perception information and a current heading range of the autonomous vehicle; and
when the candidate destination is provided as a plurality of candidate destinations, selecting one destination from among the candidate destinations based on a maximum vertical movement distance of each of the candidate destinations.

2. The method of claim 1, further comprising excluding lane information from the forward perception information.

3. The method of claim 1, further comprising:
perceiving an object in front of the autonomous vehicle based on the forward perception information and determining a location and movement direction of the object; and
setting a risk area based on the location and movement direction of the object and excluding the risk area from the destination generation area.

4. The method of claim 3, wherein, in the generating of the candidate destination, a point that is reached only after passing through the risk area is excluded from the candidate destination.

5. The method of claim 1, wherein, in the selecting of the destination, when the candidate destination is provided as the plurality of candidate destinations, one destination is selected from among the candidate destinations based on a heading value and the maximum vertical movement distance maintained to reach each of the candidate destinations.

6. A system for generating a destination for an emergency response of an autonomous vehicle, the system comprising:
a memory configured to store computer-readable instructions; and
at least one processor configured to execute the instructions,
wherein the at least one processor is configured to execute the instructions to:
generate forward perception information based on data collected from a sensor mounted on the autonomous vehicle;
set a destination generation area based on the forward perception information;
generate a candidate destination in the destination generation area based on the forward perception information and a current heading range of the autonomous vehicle; and
when the candidate destination is provided as a plurality of candidate destinations, select one destination from among the candidate destinations based on a maximum vertical movement distance of each of the candidate destinations.

7. The system of claim 6, wherein the at least one processor excludes lane information from the forward perception information.

8. The system of claim 6, wherein the at least one processor perceives an object in front of the autonomous vehicle based on the forward perception information, determines a location and movement direction of the object, sets a risk area based on the location and movement direction of the object, and excludes the risk area from the destination generation area.

9. The system of claim 8, wherein the at least one processor excludes a point that is reached only after passing through the risk area from the candidate destination.

10. The system of claim 6, wherein, when there are the plurality of candidate destinations, the at least one processor selects one destination from among the candidate destinations based on the maximum vertical movement distance and a heading value maintained to reach each of the candidate destinations.

11. An autonomous driving system for controlling an autonomous vehicle, comprising a system for generating a destination that generates the destination of the autonomous vehicle for an emergency response,
wherein, when a failure or abnormal situation of the autonomous vehicle is detected, the autonomous driving system takes over a system state to a fallback state, and
when the system state is taken over to the fallback state, the system for generating a destination generates forward perception information based on data collected from a sensor mounted on the autonomous vehicle, sets a destination generation area based on the forward perception information, generates a candidate destination in the destination generation area based on the forward perception information and a current heading range of the autonomous vehicle, and when there are the plurality of candidate destinations, selects one destination from among the candidate destinations based on a maximum vertical movement distance of each of the candidate destinations.
